(19) United States
(12) Patent Application Publication
(10) Pub. No.: US 2007/0000751 A1
(43) Pub. Date: Jan. 4, 2007

(54) MFP having counterfeit detection function

(75) Inventor: Hyoung-kyu Kim, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/434,720

(22) Filed: May 17, 2006

(30) Foreign Application Priority Data
Jul. 1, 2005 (KR) 2005-59115

(51) Int. Cl. G07D 7/00

(52) U.S. Cl. 194/207

(57) ABSTRACT

A multi-function peripheral device includes a scanning unit provided with a lamp that reads an image of an object to be copied, and an ultraviolet (UV) lamp that irradiates ultraviolet rays onto the object for the purpose of detecting a fluorescent substance on the object; a printing unit that prints an image data read by the scanning unit; and a controller that determines a counterfeit when the fluorescent substance is not detected on the object under the UV lamp and thereby, giving a visual or audible warning to a user.

### CROSS-REFERENCE TO RELATED APPLICATIONS

This application claims the benefit of Korean Patent Application No. 2005-59115, filed Jul. 1, 2005, in the Korean Intellectual Property Office, the disclosure of which is incorporated herein by reference.

### BACKGROUND OF THE INVENTION

1. Field of the Invention

Aspects of the present invention relates to a multi-function peripheral device (MFP) equipped with a counterfeit detection function and a banknote copy protection function.

2. Description of the Related Art

In general, an MFP incorporates at least two functions of a printer, a fax machine, a scanner and a copier into a single product, and is ideal for any small or home office in that one office machine is capable of doing various types of office work. In particular, an MFP that has a print engine that prints in color has a wide range of applications because it can also be used as a color copy machine.

There is, however, a dark side to the remarkable improvements in the print quality of a copy machine or an MFP: unauthorized copying or other misappropriation of the print technology for counterfeiting, such as, for example, making color copies of genuine banknotes or paper currency. A number of counterfeit detection methods have been suggested. In the case of Korean banknotes, gold, silver or green metal foil is attached to the surface of the banknote, so that the metal foil illuminates under light but becomes dark when copied. In addition, a central pattern on a genuine banknote is painted with fluorescent ink to illuminate specific fluorescent colors when placed under an ultraviolet fluorescent lamp. Nevertheless, the best way to prevent counterfeiting may be developing new MFPs equipped with a counterfeit detection function and a banknote copy protection function. Fortunately, much research is now in progress for this purpose.

### SUMMARY OF THE INVENTION

It is, therefore, an aspect of the present invention to provide an MFP equipped with a counterfeit detection function and a banknote copy protection function.

Additional aspects and/or advantages of the invention will be set forth in part in the description which follows and, in part, will be obvious from the description, or may be learned by practice of the invention.

According to an aspect of the present invention, there is provided an MFP (multi-function peripheral device), including: a scanning unit provided with a lamp that reads an image of an object to be copied, such as an object placed on the scanning unit, and an ultraviolet (UV) lamp that irradiates ultraviolet rays onto the object such that if a fluorescent substance is present on the object, the fluorescent substance fluoresces in response to the ultraviolet rays; a printing unit that prints an image data read by the scanning unit; and a controller that determines whether a fluorescent substance is present on the object and gives a visual or audible warning to a user if a fluorescent substance is not detected on the object under the UV lamp.

Preferably, although not necessarily, the object is a banknote, and the MFP detects whether the banknote is a counterfeit. In particular, the controller may determine whether the banknote is genuine or counterfeit by determining whether or not a fluorescent substance is present on the object and if a fluorescent substance is present on the object, then determining whether or not the fluorescent substance is in a designated pattern that indicates a genuine banknote.

In an exemplary embodiment, the controller controls the printing unit to output a message such as, for example, “Sample (genuine)” if the fluorescent substance with a designated pattern exists on the banknote, and to output a message such as, for example “Sample (counterfeit)” if the fluorescent substance with a designated pattern does not exist on the banknote.

Preferably, although not necessarily, the message indicating that the banknote is genuine and the message indicating that the banknote is counterfeit are written superposingly on a printed image of the banknote.

Another aspect of the present invention relates to a multi-function peripheral device, comprising a scanning unit provided with a lamp that reads an image of one or more banknotes placed on the scanning unit, and an ultraviolet lamp that irradiates ultraviolet rays onto the one or more banknotes, wherein, if a fluorescent substance is present on the one or more banknotes, the fluorescent substance fluoresces in response to the ultraviolet rays; a printing unit that prints the image of the one or more banknotes read by the scanning unit; and a controller that recognizes individual banknotes of the one or more banknotes placed on the scanning unit and for each banknote, determines whether the banknote is genuine or counterfeit by determining whether or not a fluorescent substance is present on the banknote and if a fluorescent substance is present on the banknote, then determining whether or not the fluorescent substance is in a designated pattern that indicates a genuine banknote, and wherein if the controller determines that a banknote is genuine, the controller directs the printing unit to output a message superposingly on the printed image of the banknote indicating that the banknote is genuine and if the controller determines that a banknote is counterfeit, the controller directs the printing unit to output a message superposingly on the printed image of the banknote indicating that the banknote is counterfeit.

Another aspect of the present invention provides an MFP (multi-function peripheral device), including: a scanning unit provided with a lamp that reads an image of an object to be copied, and an ultraviolet (UV) lamp that irradiates ultraviolet rays onto wherein, if a fluorescent substance is present on the object, the fluorescent substance fluoresces in response to the ultraviolet rays; a printing unit that prints image data read by the scanning unit; and a controller that determines whether the object is a genuine banknote by determining if the fluorescent substance exists on the object, and that provides a user with a warning message that copying of the object is prohibited by law if the controller determines that the object is a genuine banknote.

In an exemplary embodiment, the controller controls the printing unit to print a warning message “Sample (copying is prohibited by law)” superposingly on a banknote image, or stops the operation of the MFP while outputting an alarm.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic view showing a part of an MFP, in accordance an aspect of the present invention and having banknotes positioned to be scanned or copied;

FIG. 2 illustrates banknote copies printed out by an MFP having a counterfeit detection function, in accordance with an aspect of the present invention; and

FIG. 3 illustrates banknote copies printed out by an MFP having a banknote copy protection function, in accordance with an aspect of the present invention

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

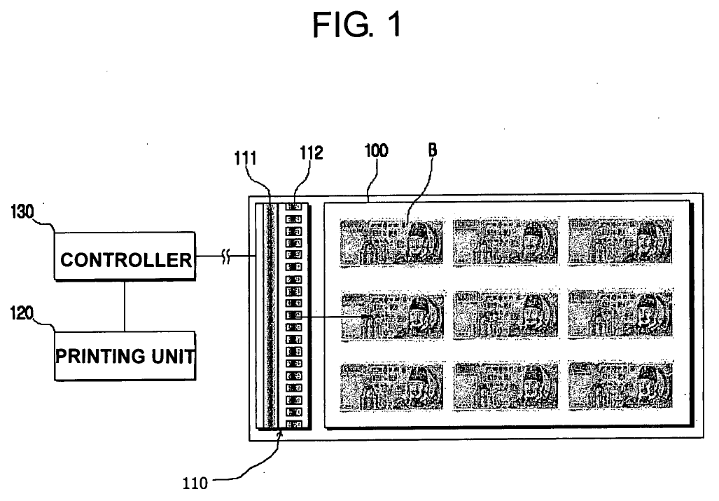

FIG. 1 is a schematic view showing a part of an MFP (multi-function peripheral device) according to an aspect of the present invention.

As shown in FIG. 1, the MFP includes a flat bed 100, a scanning unit 110, a printing unit 120, and a controller 130.

The flat bed 100 is made of transparent materials such as glass. An object to be copied is placed on the flat bed 100, and the scanning unit 110, reciprocating under the flat bed 100, irradiates a light onto the object and reads an image.

The scanning unit 110 includes an RGB lamp 111, a UV lamp 112, and a CCD module (not shown).

The RGB lamp 111 irradiates visible rays onto the object, and the UV lamp 112, together with the RGB lamp 111, irradiates a UV ray with a predetermined wavelength onto the object to read the image.

The printing unit 120 prints the image read by the scanning unit 110, under a control signal of the controller 130. The printing unit 120 may comprise an inkjet printing system or a laser printing system using a powder or liquid developer or any other type of device capable of printing. Since the configuration of the printing unit 120 is not the main concern of the present invention, it will not be explained in detail here.

The controller 130 determines whether the object is a counterfeit by checking whether the object contains a fluorescent substance reacting to the ultraviolet ray emitted from the UV lamp 112, and warns (visually and/or audibly) a user about the checking result. The controller 130 includes a detector that detects fluorescence, and may include pattern recognition capability to determine if a detected fluorescence is in a specific pattern.

For example, if the object read by the scanning unit 110 is a genuine banknote of a type that has a fluorescent substance with a specific pattern painted on the banknote, the controller 130 detects the fluorescent substance when the fluorescent substance reacts to the ultraviolet ray from the UV lamp 112, determines whether the fluorescent substance is in the specific pattern that indicates a genuine banknote and displays a message on a printout or on a display unit of the MFP saying that the object is not a counterfeit, or outputs a voice signal saying that “This is a genuine banknote” or similar language. However, if no fluorescent substance having a specific pattern is detected from the object, the controller 130 determines that the object of concern is a counterfeit and warns a user through a printout or an alarm. The controller 130 may include a memory that contains data regarding currency and banknotes worldwide that include fluorescent ink as an indicator of genuineness.

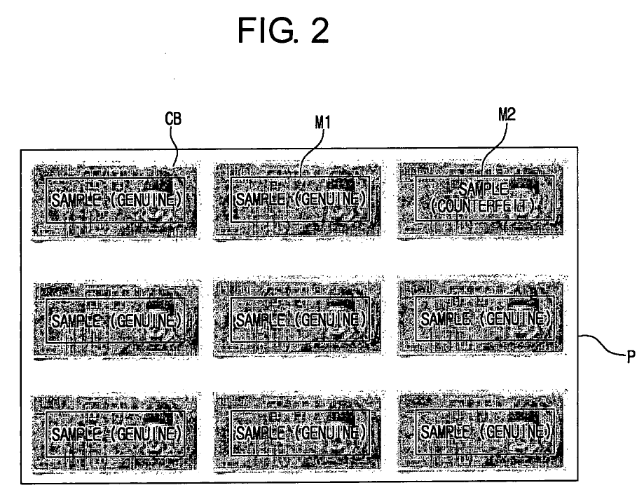

As shown in FIG. 1, if many banknotes are placed on the flat bed 100 for counterfeit detection, the scanning unit 110 irradiates visible rays and ultraviolet rays onto the banknotes B at the same time. Using the image read by the scanning unit 110, the controller 130 recognizes the banknotes B separately from a scanned image, and determines whether each of the banknotes B contains a fluorescent substance with a specific pattern reacting to the ultraviolet rays. The banknotes B having such a fluorescent substance are recognized as genuine or authentic, whereas the banknotes B having no such fluorescent substance are recognized as counterfeits. These results are then provided visually to the user through a printout P, as shown in FIG. 2.

That is to say, referring to FIG. 2, if a banknote B (FIG. 1) contains the target fluorescent substance with the designated pattern, the controller 130 recognizes it as a genuine banknote, and controls the printing unit 120 to print a message Ml such as “Sample (genuine)” superposingly on a banknote image CB and output it as a printout R On the other hand, if banknote B does not contain the target fluorescent substance with the designated pattern, the controller 130 recognizes it as a counterfeit, and controls the printing unit 120 to print a message M2 such as “Sample (counterfeit)” superposingly on a banknote image CB and to output it as a printout P.

If a multi-function peripheral device is configured to allow a user to detect whether a banknote is genuine or counterfeit, the multi-function peripheral device may further include a selector that directs the controller to select or unselect counterfeit detection. In this way, counterfeit detection can be unselected so that the multi-function peripheral device can be used normally to scan and copy other items besides banknotes. A fluorescent material will not be present on ordinary items that are scanned and copied, but with the counterfeit detection unselected, the controller will not direct the printer to print a message superposingly on the printed image of the ordinary items. Alternatively, a controller may recognize the presence of one or more banknotes on the scanning unit by image recognition and may itself activate counterfeit detection when a banknote, whether real or counterfeit, is detected. However, the counterfeit prevention of the multi-function peripheral device as described below is not selectable and should remain constantly on to prevent counterfeiting. In particular, the multifunction peripheral device will irradiate any object to be copied with the UV light of the predetermined wavelength and the controller 130 will determine whether the fluorescent substance is in the specific pattern that indicates a genuine banknote.

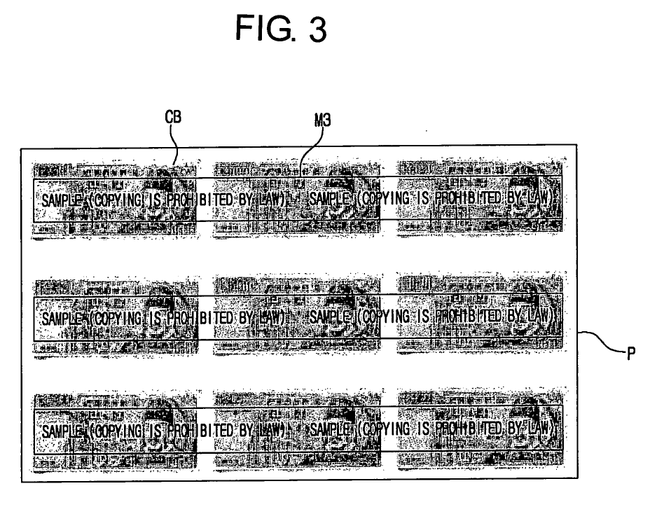

According to another aspect, a multi-function peripheral device may be configured to prevent copying or counterfeiting of a banknote or other object painted with a fluorescent substance with a specific pattern. If the target fluorescent substance reacting to the ultraviolet rays is detected in an object to be copied, the controller 130 in addition to detecting the fluorescence emitted by the object, analyzes the detected fluorescent pattern, such as, for example, by comparing the detected fluorescent pattern with a database to determine whether the object to be copies is an object such as a banknote or a gift certificate of which unauthorized copying or duplication is strictly prohibited by law. In such case, the controller 130 controls the printing unit to print a message M3 such as “Sample (copying is prohibited by law)” superposingly on a banknote image CB and output it as a printout P as shown in FIG. 3. The controller 130 may also stop the operation of the MFP while causing the MFP to sound an alarm, such as, for example, by emitting a beeping sound.

As depicted in the drawings, the scanning unit 110 is capable of reading many banknotes at once, when the banknotes are placed non-overlappingly on the scanning unit 110. Alternatively, banknotes may be fed to the scanning unit 110 by an automatic document feeder (ADF) and then read in sequence, either one by one or collectively.

Therefore, simply by installing the UV lamp 112 in an existing MFP and providing a controller 130 or modifying an existing controller to detect a fluorescent substance on an object read by the scanning unit 110 and to determine whether the fluorescent substance is in the specific pattern that indicates a genuine banknote, the MFP is equipped with a counterfeit detection function and a banknote copy protection function. In other words, without purchasing a separate counterfeit detecting device, the MFP of the present invention alone can detect counterfeits. If a person knowingly or mistakenly copies a banknote, the resulting printout not only shows an image of the banknote but also shows a warning message printed superposingly over the image of the banknote. Needless to say, this printout cannot be used with other genuine banknotes.

In conclusion, an MFP having the counterfeit detection function according to aspects of the present invention can significantly reduce crimes related to unauthorized and illegal copying of banknotes by outputting a warning message printed over the image of a genuine banknote. Therefore, whether a person knowingly or mistakenly copies a genuine banknote, he cannot pass off the resulting printout as being a genuine banknote.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A multi-function peripheral device, comprising:
a scanning unit provided with a lamp that reads an image of an object placed on the scanning unit, and an ultraviolet lamp that irradiates ultraviolet rays onto the object, wherein, if a fluorescent substance is present on the object, the fluorescent substance fluoresces in response to the ultraviolet rays;
a printing unit that prints image data read by the scanning unit; and
a controller that determines whether a fluorescent substance is present on the object and gives a visual or audible indication or warning to a user according to whether the fluorescent substance is detected on the object under the ultraviolet lamp.

2. The multi-function peripheral device of claim 1, wherein the controller gives the visual or audible indication to the user if the fluorescent substance is detected on the object under the ultraviolet lamp.

3. The multi-function peripheral device of claim 1, wherein the controller gives the visual or audible warning to the user if the fluorescent substance is not detected on the object under the ultraviolet lamp.

4. The multi-function peripheral device according to claim 1, wherein the object is a banknote, and wherein the controller determines whether the banknote is genuine or counterfeit by determining whether the fluorescent substance is present on the object and if the fluorescent substance is present on the object, then determining whether the fluorescent substance is in a designated pattern that indicates a genuine banknote.

5. The multi-function peripheral device of claim 4, wherein the controller if the controller detects a fluorescent substance on the banknote, the controller further determines whether the fluorescent substance is in a designated pattern that indicates a genuine banknote by comparing a detected pattern of the fluorescent substance on the banknote with preset data that indicates a genuine banknote.

6. The multi-function peripheral device according to claim 5, wherein the printing unit outputs a message indicating that the banknote is genuine if the controller determines that the fluorescent substance with a designated pattern exists on the banknote and outputs a message indicating that the banknote is counterfeit if the controller determines that the fluorescent substance with the designated pattern does not exist on the banknote.

7. The multi-function peripheral device according to claim 6, wherein the message indicating that the banknote is genuine or the message indicating that the banknote is counterfeit is written superposingly on a printed image of the banknote.

8. A multi-function peripheral device, comprising:
a scanning unit provided with a lamp that reads an image of one or more banknotes placed on the scanning unit, and an ultraviolet lamp that irradiates ultraviolet rays onto the one or more banknotes, wherein, if a fluorescent substance is present on the one or more banknotes, the fluorescent substance fluoresces in response to the ultraviolet rays;
a printing unit that prints the image of the one or more banknotes read by the scanning unit; and
a controller that recognizes individual banknotes of the one or more banknotes placed on the scanning unit and for each banknote, determines whether the banknote is genuine or counterfeit by determining whether a fluorescent substance is present on the banknote and if the fluorescent substance is present on the banknote, then determining whether the fluorescent substance is in a designated pattern that indicates a genuine banknote, and wherein if the controller determines that a banknote is genuine, the controller directs the printing unit to output a message superposingly on the printed image of the banknote indicating that the banknote is genuine and if the controller determines that a banknote is counterfeit, the controller directs the printing unit to output a message superposingly on the printed image of the banknote indicating that the banknote is counterfeit.

9. The multi-function peripheral device of claim 8, further comprising an automatic document feeder that supplies banknotes to the scanning unit.

10. A multi-function peripheral device, comprising:
a scanning unit provided with a lamp that reads an image of an object to be copied, and an ultraviolet (UV) lamp that irradiates ultraviolet rays onto the object wherein, if a fluorescent substance is present on the object, the fluorescent substance fluoresces in response to the ultraviolet rays;
a printing unit that prints image data read by the scanning unit; and
a controller that determines whether the object is a genuine banknote and that provides a user with a warning message that copying of the object is prohibited by law if the controller determines that the object is a genuine banknote.

11. The multi-function peripheral device according to claim 10, wherein the controller determines whether the object is a genuine banknote by determining whether the fluorescent substance is present on the object.

12. The multi-function peripheral device of claim 10, wherein the controller determines whether the object is a genuine banknote by determining whether the fluorescent substance is present on the object and whether the fluorescent substance is in a predetermined pattern that indicates a genuine banknote.

13. The multi-function peripheral device of claim 10, wherein the controller determines whether the fluorescent substance is in a predetermined pattern that indicates a genuine banknote by comparing a detected pattern of the fluorescent substance on the object with preset data indicating a genuine banknote.

14. The multi-function peripheral device according to claim 10, wherein, if the controller determines that the object is a genuine banknote, the controller directs the printing unit to print a warning message superposingly on a banknote image.

15. The multi-function peripheral device according to claim 10, wherein, if the controller determines that the object is a genuine banknote, the controller prevents the multi-function peripheral device from printing an image of the object and outputs an alarm.

16. A method of detecting and notifying a user whether a banknote is genuine or counterfeit, the method comprising:
reading an image of the banknote and irradiating the banknote with ultraviolet rays on a scanning unit of a multi-function peripheral device;
determining whether a fluorescent substance is present on the banknote by detecting whether fluorescence is emitted by the banknote in response to irradiation with the ultraviolet rays and if a fluorescent substance is determined to be present, determining whether the fluorescent substance is in a designated pattern that indicates a genuine banknote by comparing the detected fluorescence with preset data; and
printing the read image of the banknote, and printing a message superposingly on the printed image of the banknote to indicate that the banknote is genuine or counterfeit, depending on whether the fluorescent substance with a designated pattern is determined to be present on the banknote.

17. The method of claim 16, wherein the method includes reading the image of a plurality of banknotes at one time while irradiating the banknotes with ultraviolet rays;
individually determining whether each banknote of the plurality of banknotes is genuine or counterfeit;
printing the read image of the plurality of banknotes; and
superposingly printing a message indicating that the banknote is genuine on the printed images of banknotes that are determined to be genuine and superposingly printing a message indicating that the banknote is counterfeit on the printed images of banknotes that are determined to be counterfeit.

18. A method of preventing a genuine banknote from being copied by a multifunction peripheral device, the method comprising:
reading an image of an object and irradiating the object with ultraviolet rays on a scanning unit of the multi-function peripheral device;
determining whether the object is a genuine banknote by determining whether a fluorescent substance is present on the object by detecting whether fluorescence is emitted by the object in response to irradiation with the ultraviolet rays and if a fluorescent substance is determined to be present, determining whether the fluorescent substance is in a designated pattern that indicates that the object is a genuine banknote by comparing the detected fluorescence with preset data; and
issuing a warning message if the object is determined to be a genuine banknote.

19. The method of claim 17, including printing the read image of the object, and printing a warning message superposingly on the printed image of the object if the object is determined to be a genuine banknote.

20. The method of claim 17, including preventing the multi-function peripheral device from printing an image of the object and outputting an alarm if the object is determined to be a genuine banknote.
